(19) United States
(12) Patent Application Publication
(10) Pub. No.: US 2018/0357712 A1
(43) Pub. Date: Dec. 13, 2018

(54) System and method for sale of near expiry or expiry inventory

(71) Applicant: Israel Krasnianki, Brooklyn, NY (US)

(72) Inventor: Israel Krasnianki, Brooklyn, NY (US)

(21) Appl. No.: 15/839,262

(22) Filed: Dec. 12, 2017

Related U.S. Application Data
(60) Provisional application No. 62/433,976, filed on Dec. 14, 2016.

(51) Int. Cl. G06Q 30/08; G06Q 30/06; G06Q 10/08; G06Q 30/02

(52) U.S. Cl. CPC G06Q 30/08; G06Q 30/0641; G06Q 50/12; G06Q 30/0233; G06Q 30/0223; G06Q 10/087

(57) ABSTRACT

A system and method are provided for live real-time facilitation sales of items that are at, near, or past a commercial expiration date.

### BACKGROUND OF THE INVENTION

The invention provides a system and method for businesses to sell inventory that is near its commercial expiration date or past the currently, those businesses that engage in commerce with items that have an expiration date have no method to expedite the sale of those items. The present invention addresses this need by providing a live real-time bidding and ordering platform in which such items can be sold.

### SUMMARY OF THE INVENTION

1) Live bidding for travel, leisure and entertainment technology in the market.
2) Live system offering spoiled inventory to highest bidders, both in advance and last minute. This can include specific configuration for selling items even after an official expiration date.
3) Live system offering spoiled inventory to highest bidders directly from the suppliers, both in advance and last minute through a direct sale.
4) Live reservation/booking system to allow use of points or mix of cash and points as payment units.

### BRIEF DESCRIPTION OF THE SEVERAL VIEWS OF THE DRAWINGS

FIG. 1 is a flowchart demonstrating the beginning of the process according to one embodiment of the present invention.

FIG. 2 is a continuation of the flowchart from FIG. 1.

FIG. 3 is a continuation of the flowchart from FIG. 2.

FIG. 4 is a continuation of the flowchart from FIG. 3.

FIG. 5 is a continuation of the flowchart from FIG. 4

FIG. 6 is a continuation of the flowchart from FIG. 5

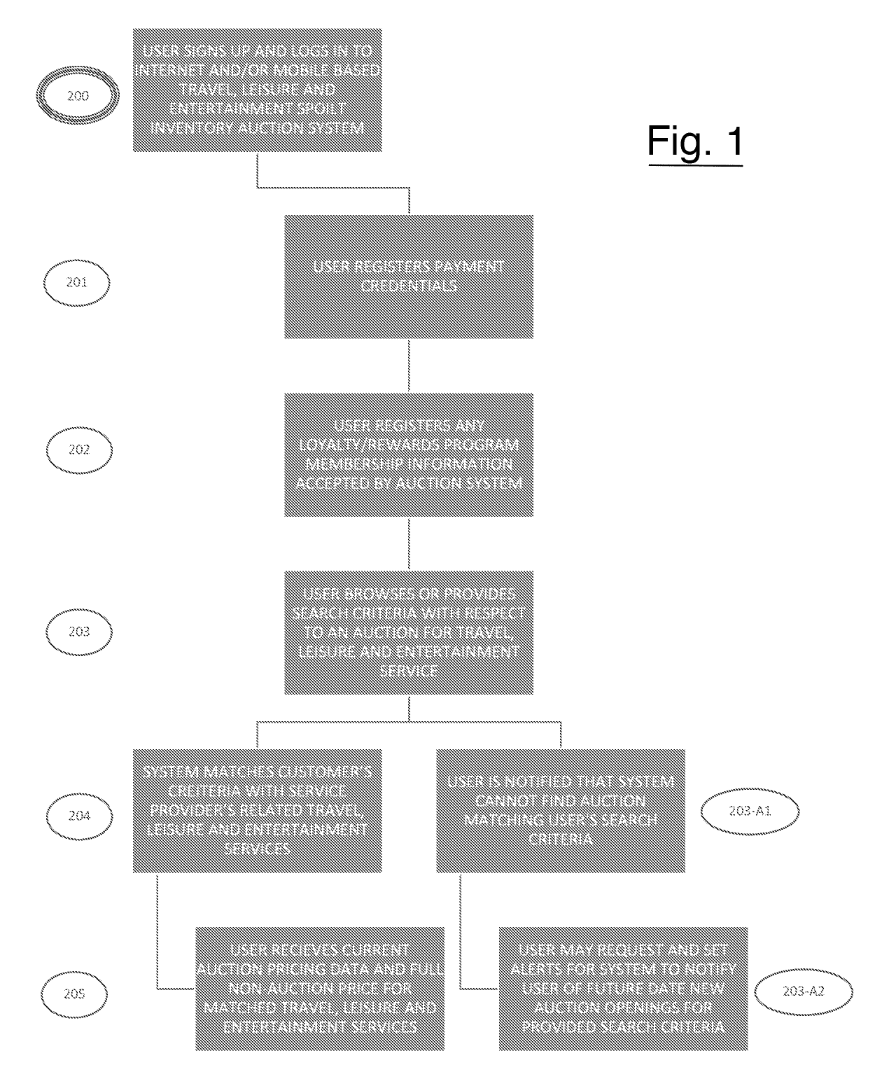

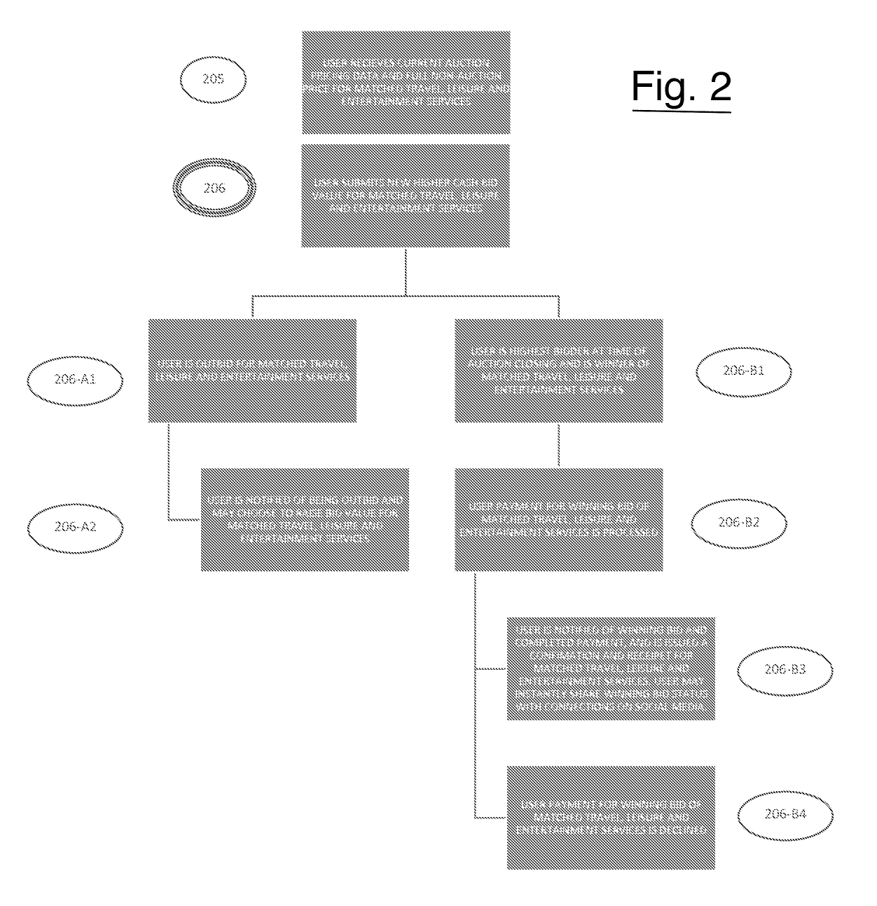

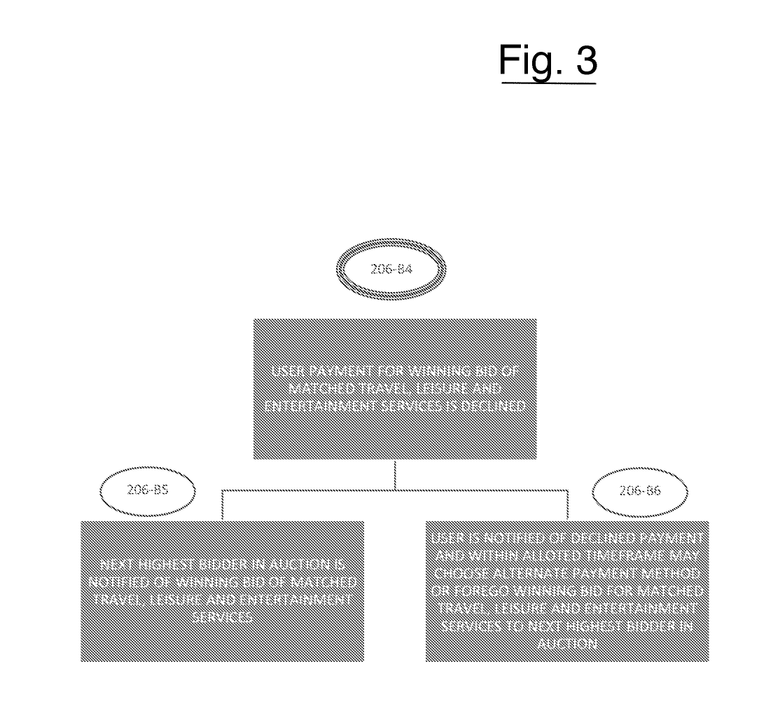

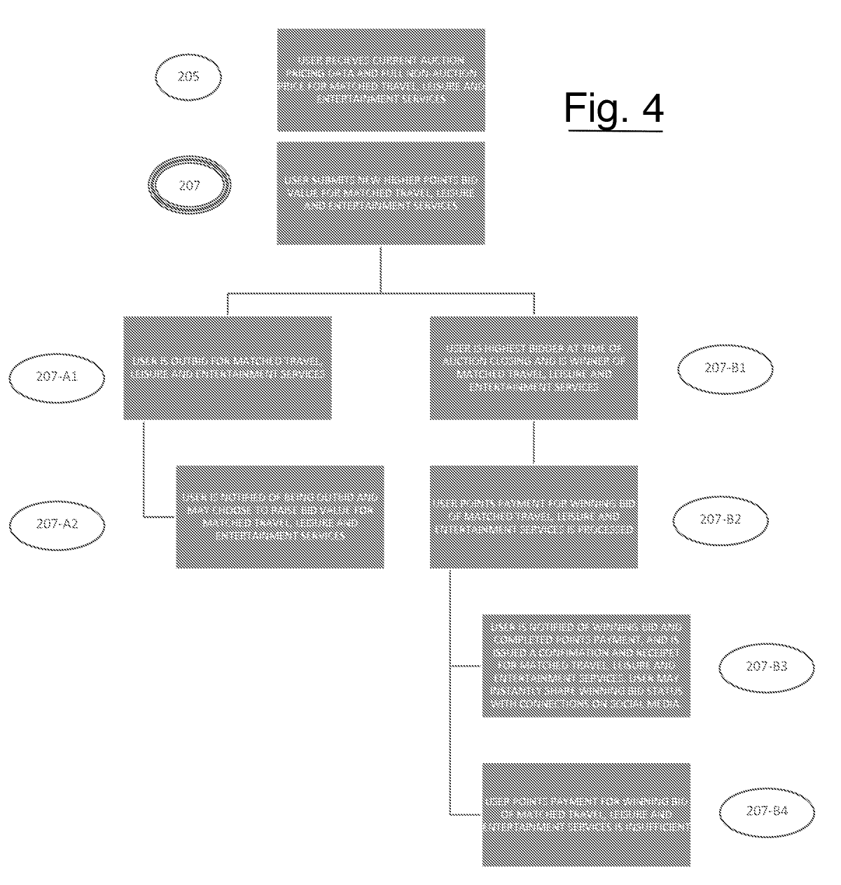

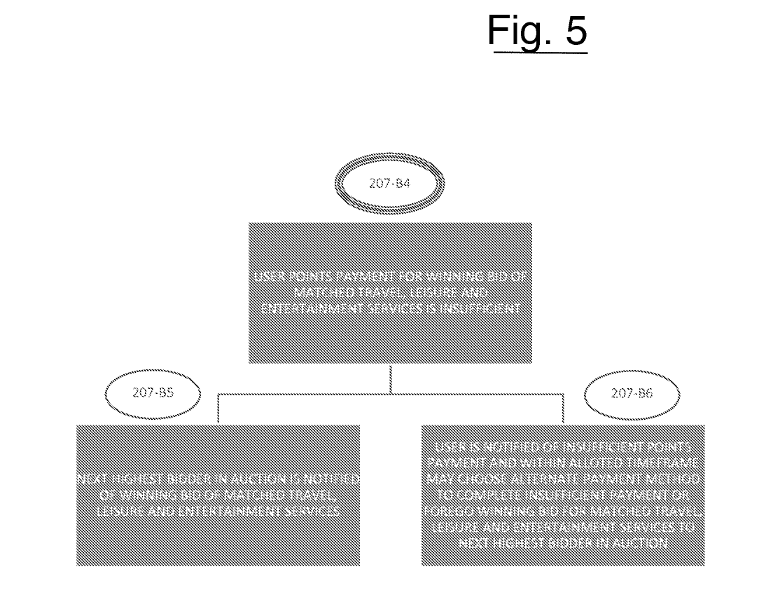

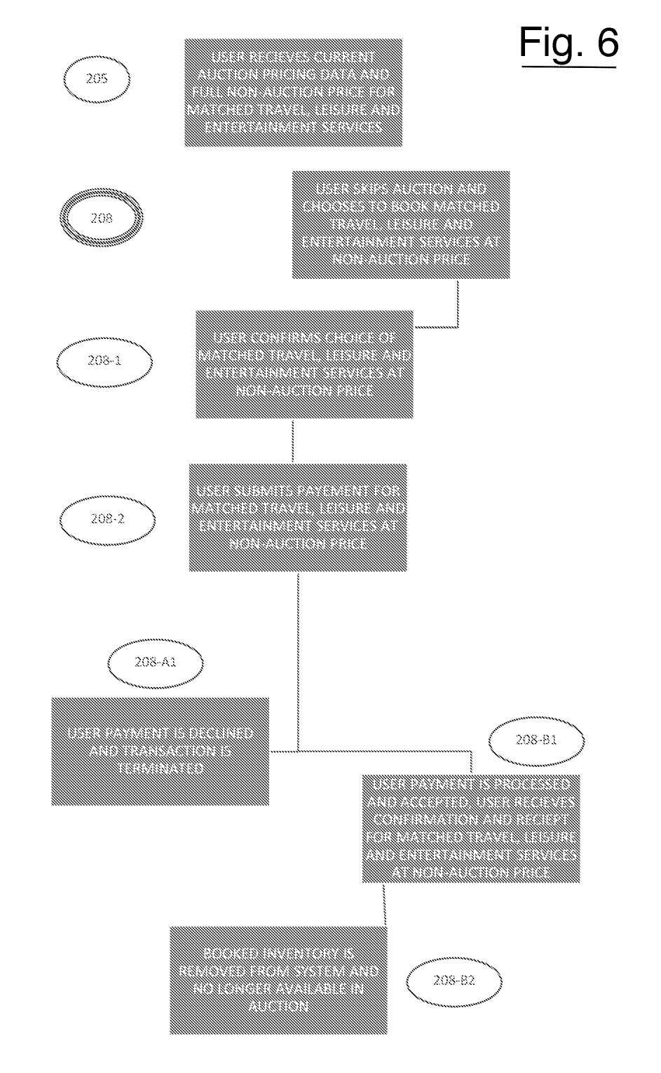

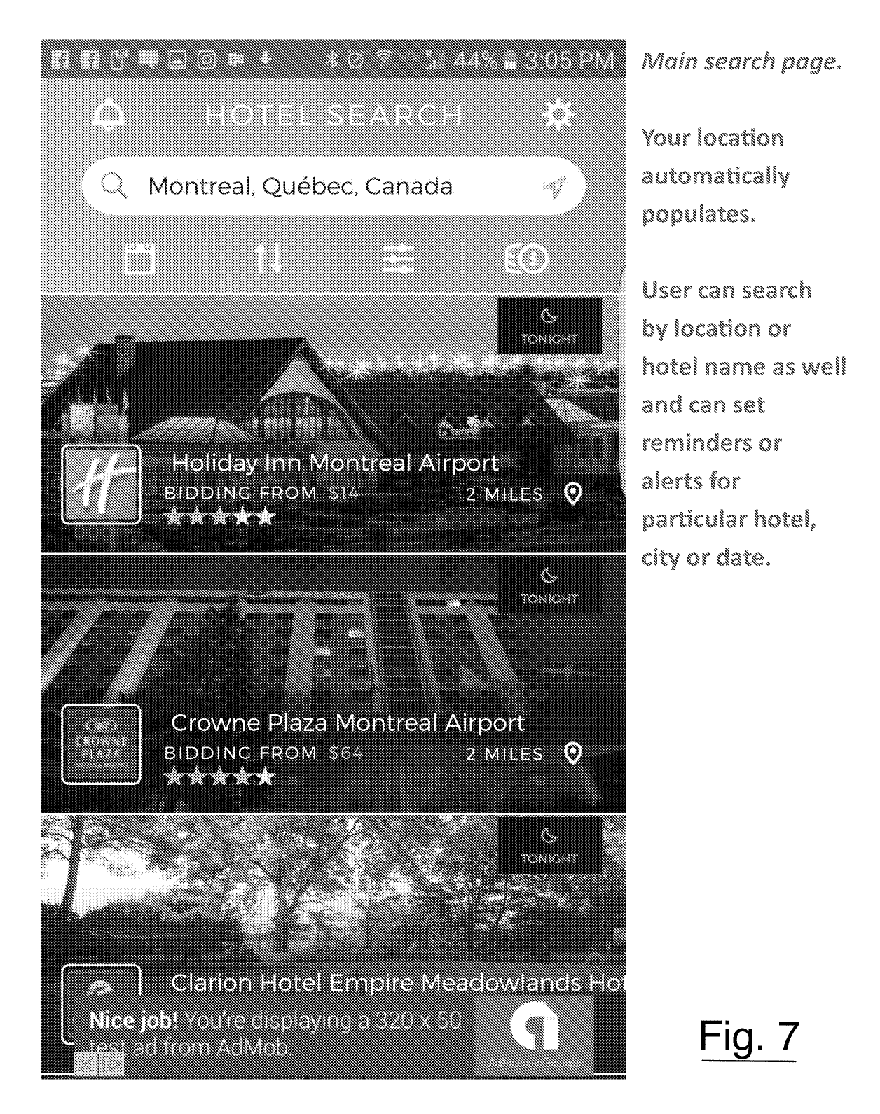

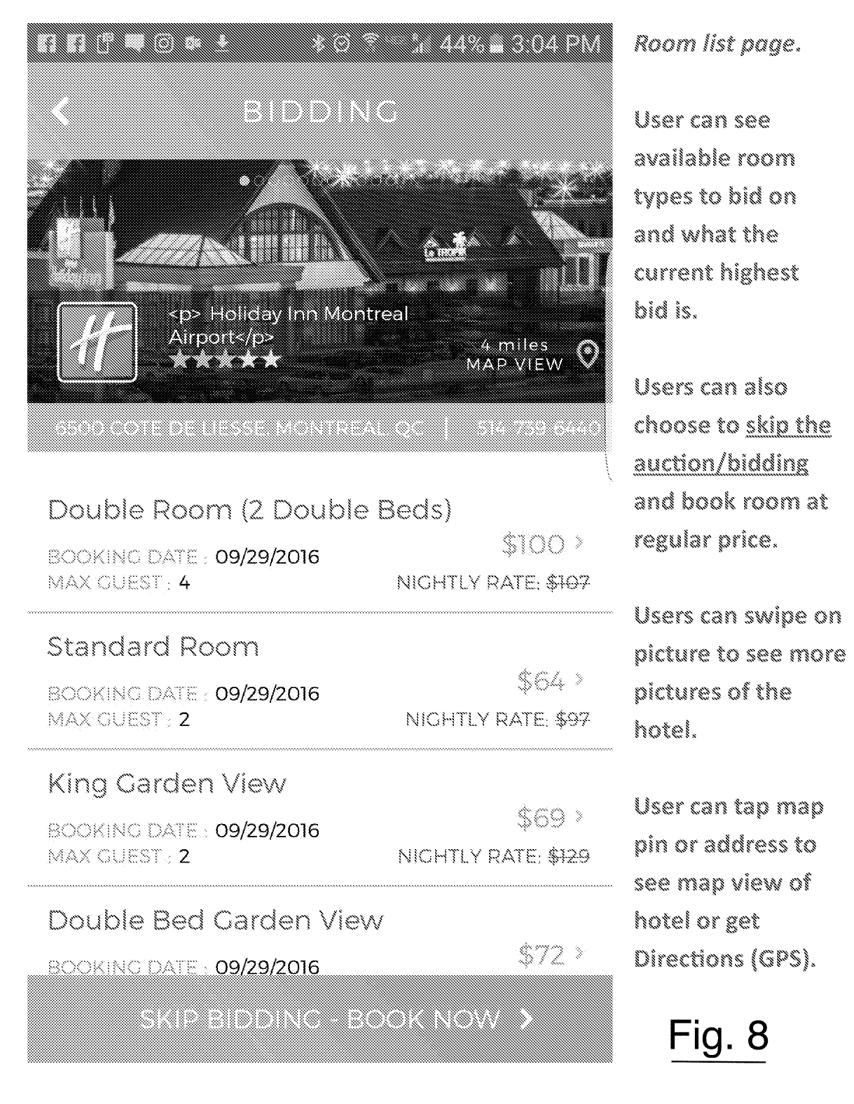

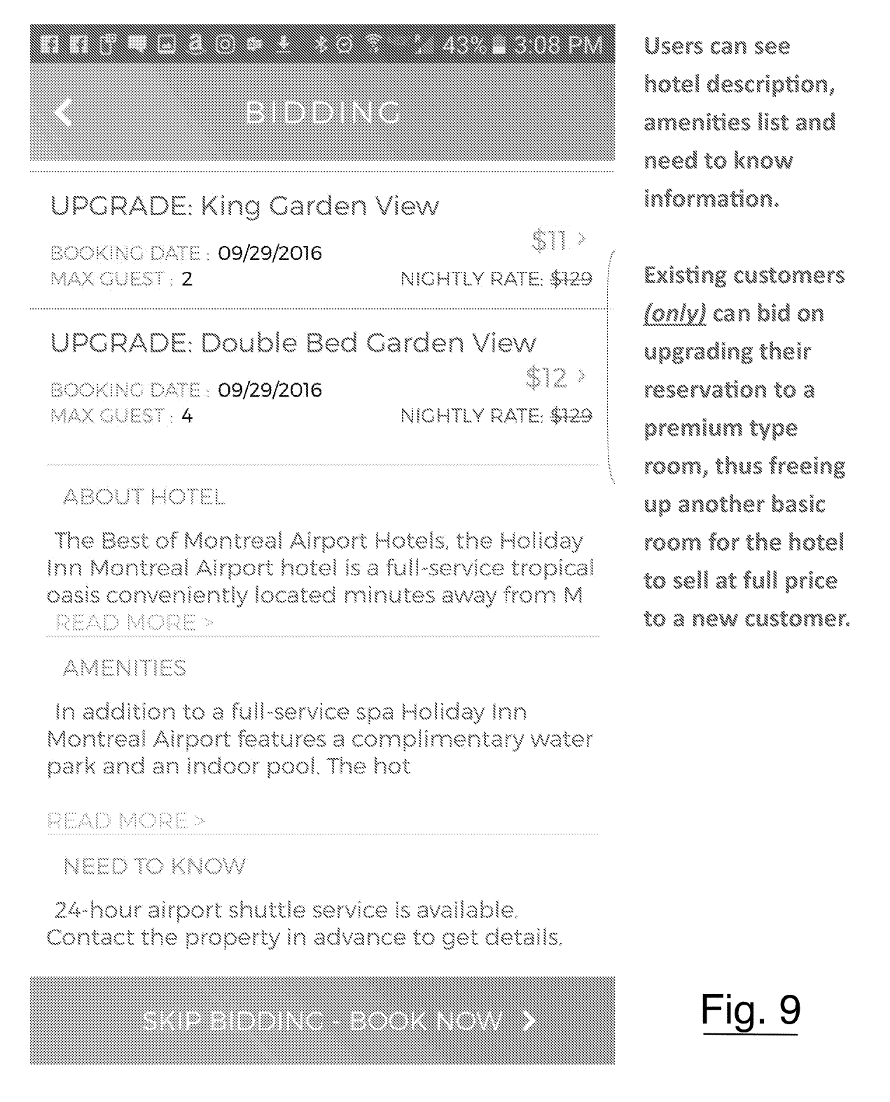

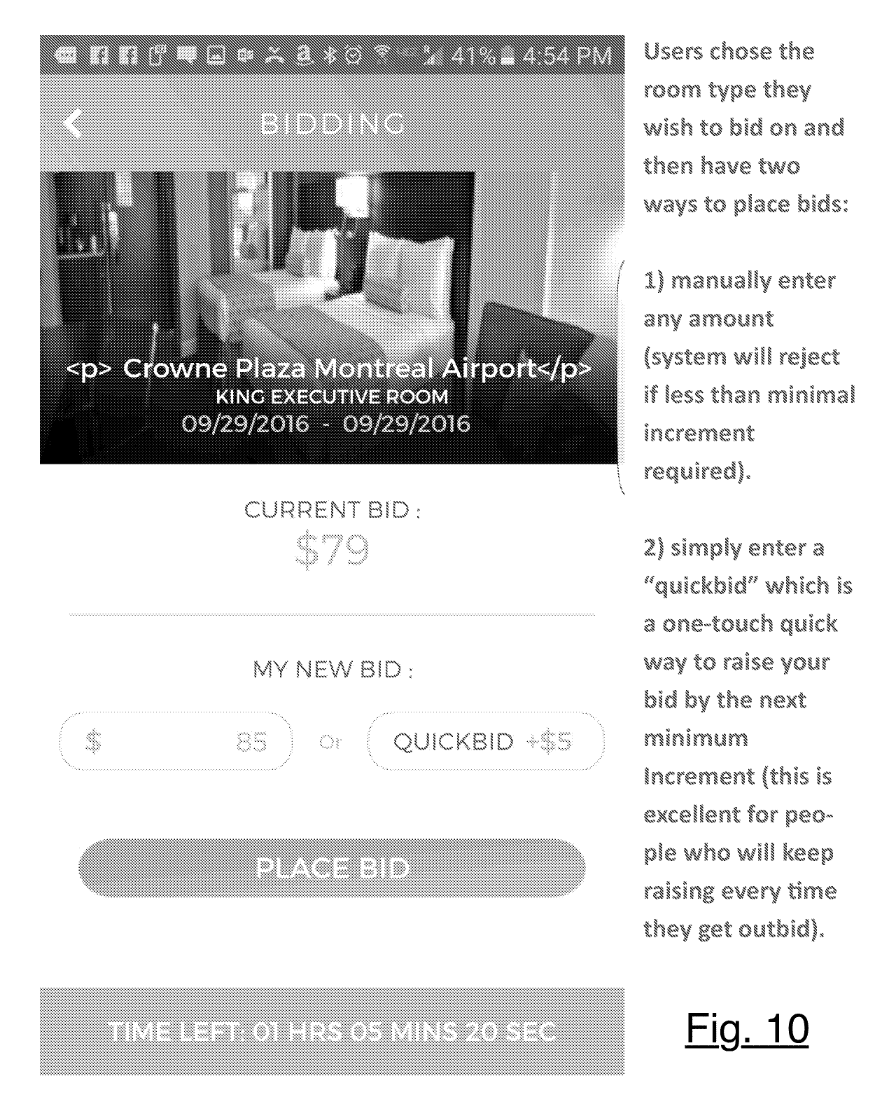

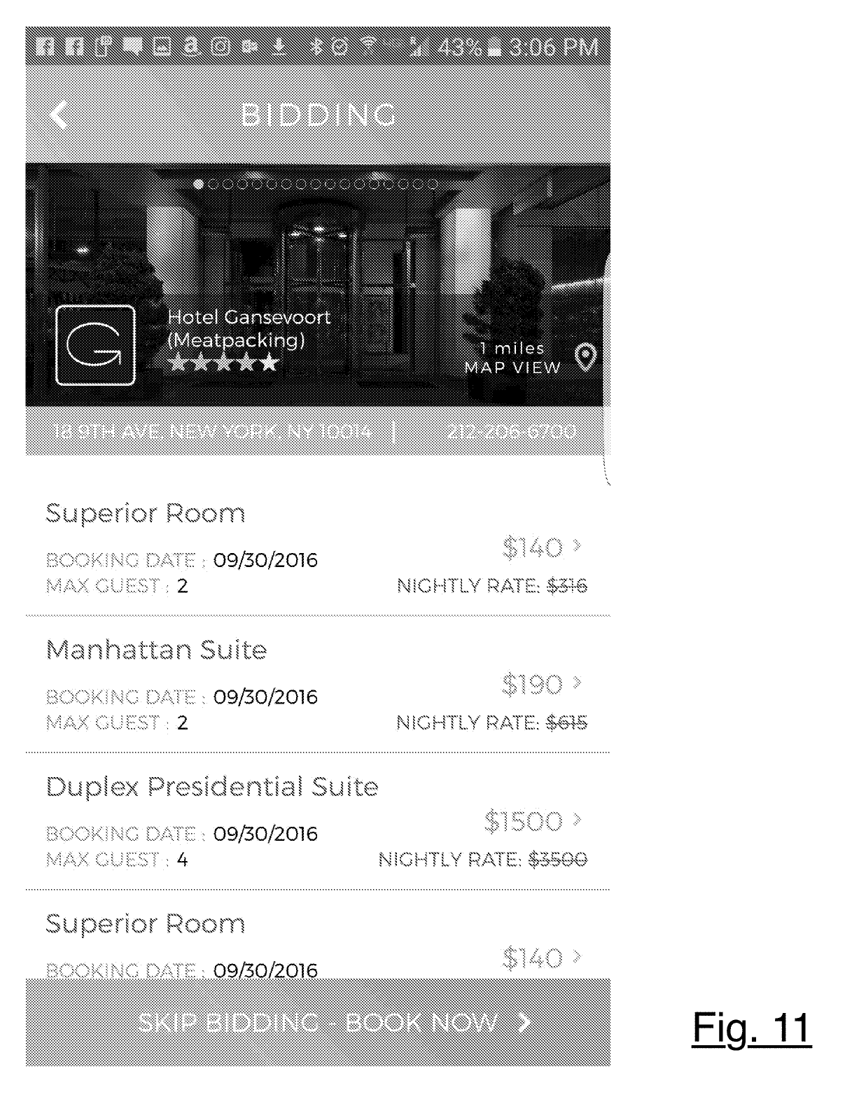

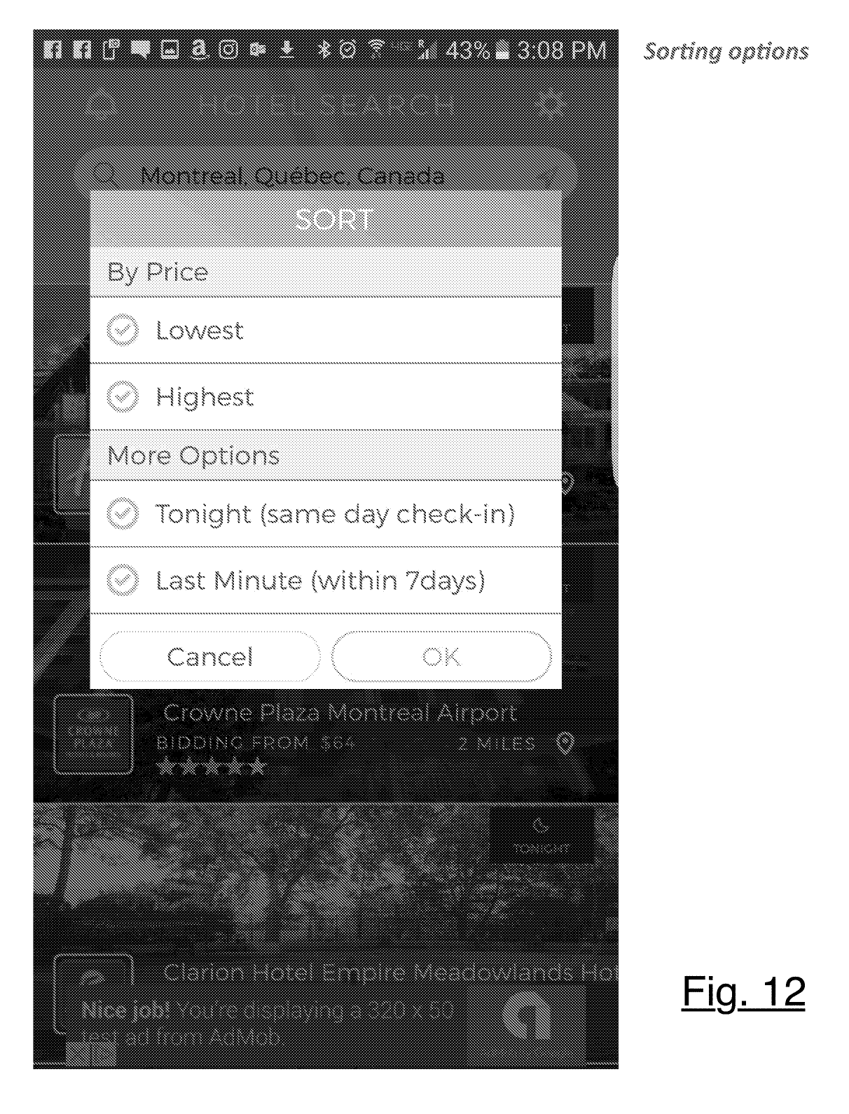

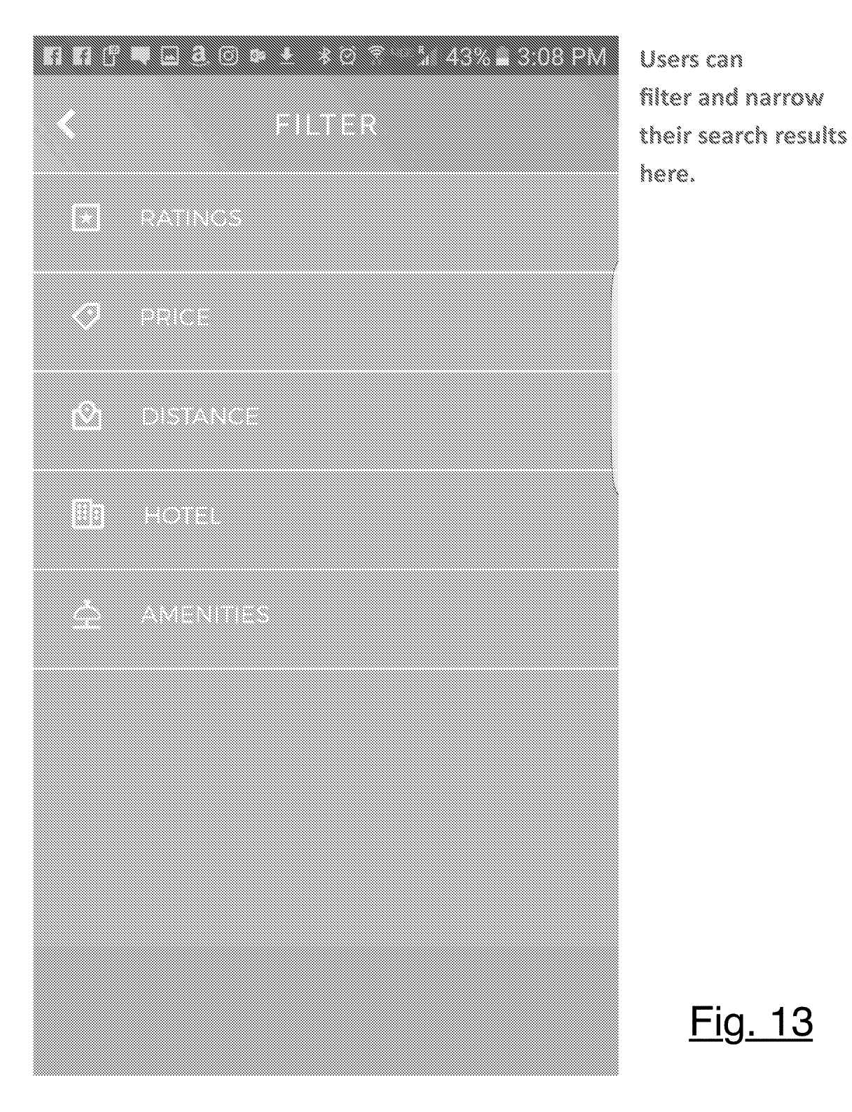

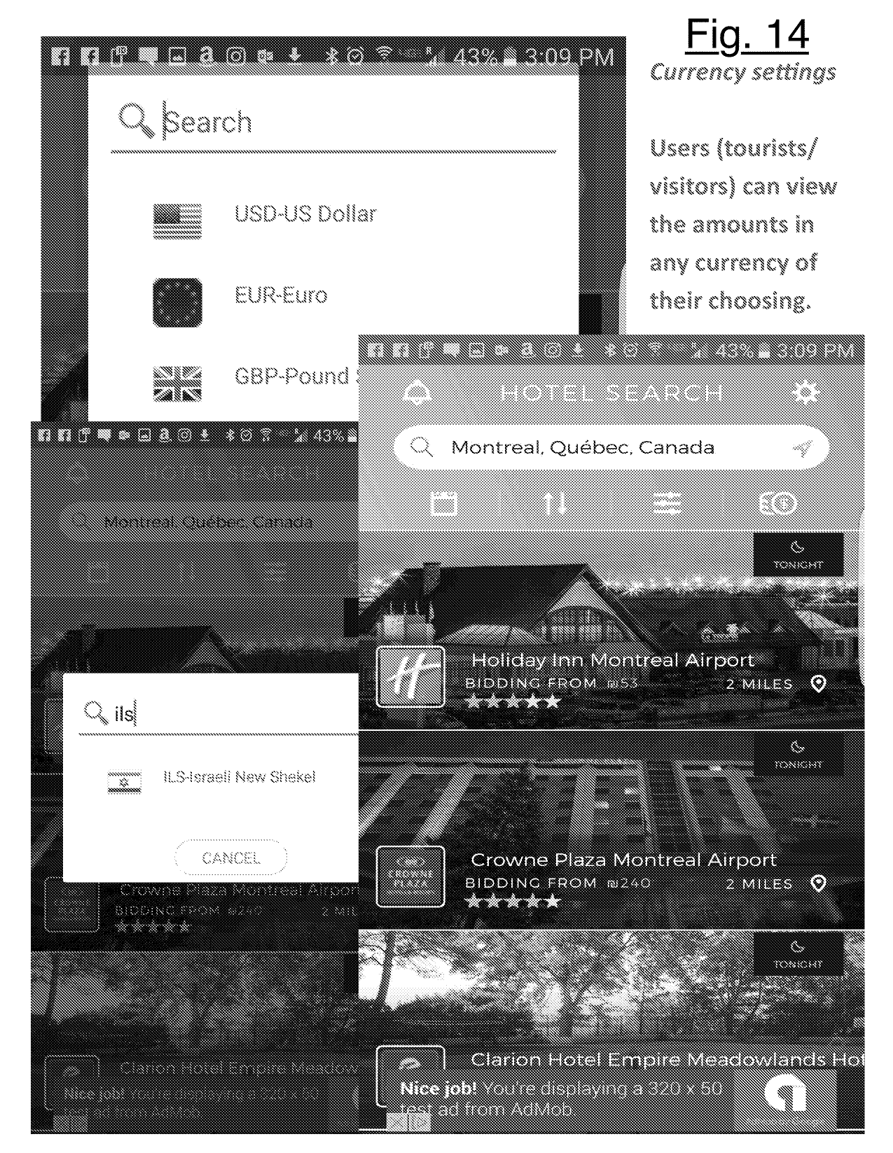

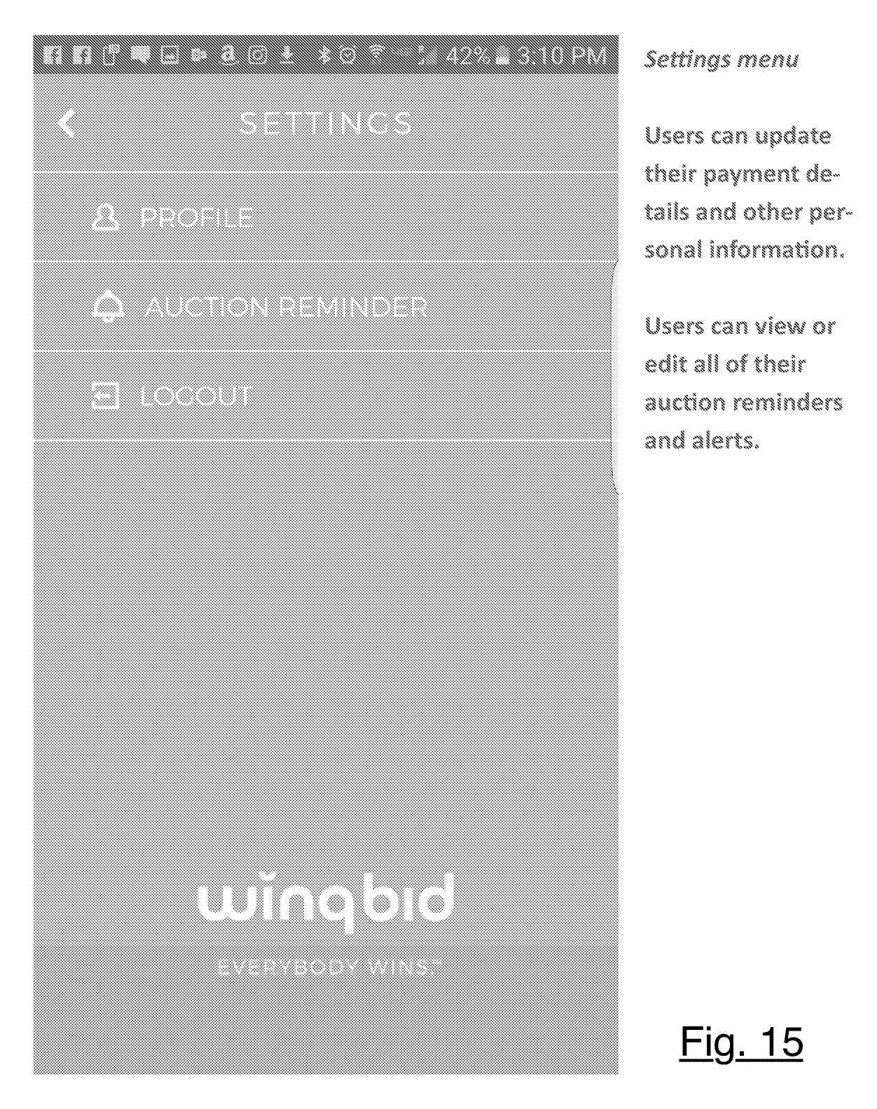

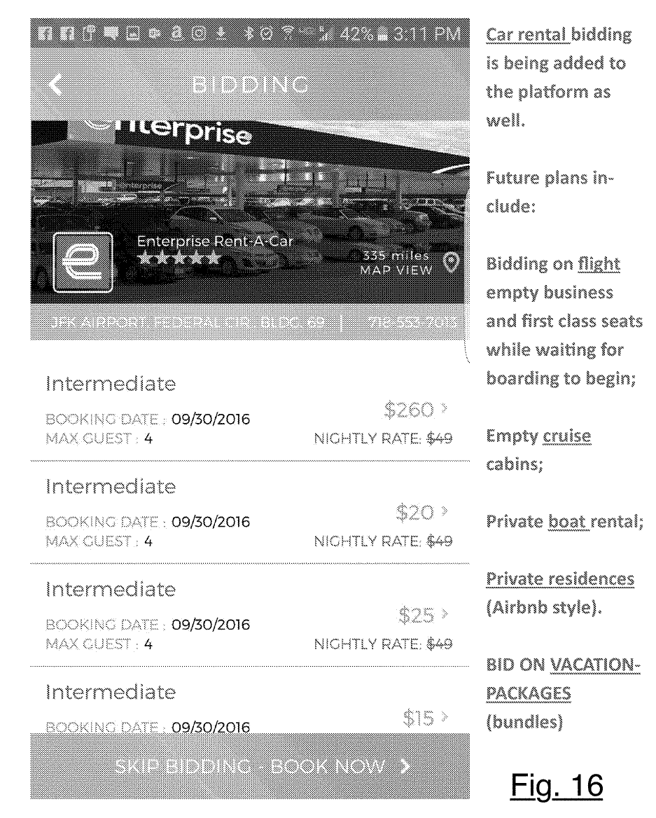

### DETAILED DESCRIPTION OF THE PREFERRED EMBODIMENT

In one embodiment, the present invention relates to both the system and method for providing sales of inventory that is either nearing commercial expiration or past commercial expiration.

In one embodiment, the system is configured to automatically detect inventory based on parameters relating to a date of near expiration or expiration to be sold by the system and method of the present invention.

In another embodiment, a user has an option to manually enter inventory that is at or near expiration.

In one nonlimiting example, a hotel room is typically booked by noon on the day of check in. A user can configure the system to capture information about a room that is not yet booked 24 hours before the noon deadline. The system can further be configured to attempt to sell the room in a more aggressive manner between the hours of noon and 10 PM on the day of check in.

In another nonlimiting example, a commercial establishment that sells perishable items can provide a configuration whereby items that are nearing a commercial expiration date are offered for sale in the system of the present invention.

In another nonlimiting example, an individual property owner can list his or her own apartment or house or venue for sale by the system.

In another nonlimiting example, the present invention provides sellers with a means to offer their product without a formally published price without devaluing their product or brand, thus remaining opaque in this offering, since no two winners are guaranteed to be paying the same amount upon successfully winning an auction.

Expiration, as used herein, does not necessarily mean a date of spoilage. Expiration is generally understood in the commercial sense as a desired date of sale.

In general, the system of the present invention includes a microprocessor-based system running a program that is selectively configured by a seller. Items that are for sale can be tangible goods, services, or combinations thereof. In one embodiment, the system is operatively associated with the sellers computerized inventory. In this embodiment, items offered for sale in automated fashion based on parameters provided by the seller.

In another embodiment, a customer can provide for a configuration whereby the system is instructed to purchase a particular item at a particular price if said item becomes available in the system.

In one nonlimiting example, a customer enters a particular hotel and instructs the system if the particular hotel has a room available at or below a specified price, automatically purchase and complete the transaction.

In another embodiment, a customer can set an alert for any one or more particular goods and/or services whereby the customer is alerted electronically should inventory matching the query become available. An alert includes, but is not limited to, an email, a text message, a push notification, or combinations thereof.

### EXAMPLE 1

### For Hotels

1) Alleviates spoilt inventory/vacant rooms/cancelled reservations (by delivering it to the highest paying customer at the shortest notice). Any way you spin it, spoilt inventory/vacant rooms equals loss of profit. WinqBid fills that loss.
2) Distributes and delivers unsold vacant rooms to highest bidder via live mobile auction
3) Ability to open bidding for anticipated and forecasted spoilt inventory in advance, as well as last-minute vacancies due to slack in demand/cancellations, etc.
4) Allows hotels to directly sell their inventory to the highest bidder without having to first sell it to a third party. Hotel is the direct merchant. WinqBid just serves as the auction house. In this way hotels aren't low-balled on the room/s rate and keep the profits made on it.
5) Higher end hotels can use slower seasons and empty rooms as a way to grab and lure lesser-income guests into trying them and spending more with them for their brand's experience and potentially securing them for multiple nights as well as future return visits.
6) Increasing additional revenues. Many hotels, especially the resorts, make money off ancillary revenue, concierge services, dining, resort and service charges and not necessarily from the rooms themselves. By using our system, these hotels can use their vacancies as way to lure guests and increase their ancillary revenues.
7) Lower income folks don't get on the promotional lists and mailers for higher quality/cost suppliers since they have never had a connection with them. Hotels are not reaching this market share with their promotional materials. Bidder information is shared with the supplier for future marketing and promotional opportunities.
8) For a hotel that is looking to be more competitive in their market, our platform collects data that serves to generate a clear determination of the average price that a new guest customer would be willing to pay for that brand's experience.
9) Every brand loyalty/membership points program wants desperately for their members to spend their points. Many points are typically needed for redemption and often times, especially lower income folks, only have some points accrued that are significant but just not enough to redeem anything valuable. Our platform solves this problem by allowing bidders to use their points as bidding units. Users can use these points to pay in full or mix and cash and points if they don't have enough. In this way users that have 2000 points just sitting around that they collected from a brand that requires a minimum of 4000 points for a room can use these points for half the bidding value.

### EXAMPLE 2

### For Consumers/Guests

1) A consumer says: My options right now—on my budget—is only to stay at a lower rated hotel lacking amenities and services I wish I could have on my budget. How can I find out if there is a better hotel with the amenities I desire that has an unsold room that will remain empty tonight? Even if I did know which hotel has vacancies, how can I communicate with them and make an offer on that room? How can I know what offer they would accept without feeling silly or rejected? If only we could solve this problem, it would be a win-win for everyone, especially my upgraded hotel experience!
2) How can I use my points—or a combination of my cash and points—to book a better hotel stay at a brand I love? I was willing to spend 200$ on a hotel stay, I wish I could add points to that amount and stay at a better brand and have a higher quality experience.
3) I wish there was a fun way to do this without feeling silly or rejected by asking a hotel if there is an empty room and how much they might consider discounting it for?

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim;

1. A system and method for selling commercial inventory comprising the steps of:
providing a program on a non-transitory computer readable medium;
providing at least one microprocessor based device to run said program, whereby said device is constructed and arranged with input, output, and communications means;
associating said program with a commercial inventory;
providing a listing of items being goods, services, or combinations thereof available for sale from said commercial inventory;
providing access to said program to a customer;
listing items in said inventory for said customer based on preset parameters;
providing a means for said customer to selectively purchase items from said commercial inventory, whereby said commercial inventory is accessible and updated in real time.

2. The system and method of claim 1 whereby said associating the program with a commercial inventory includes automatically loading said items into said listing based on a commercial expiration date.

3. The system and method of claim 1 whereby said associating the program with a commercial inventory includes manually loading said items into said listing based on a commercial expiration date.

4. The system and method of claim 1 whereby said associating the program with a commercial inventory includes automatically loading said items into said listing based on a commercial expiration date and wherein said items are listed at a time before a commercial expiration date.

5. The system and method of claim 1 whereby said associating the program with a commercial inventory includes manually loading said items into said listing based on a commercial expiration date and wherein said items are listed at a time before a commercial expiration date.

6. The system and method of claim 1 whereby said associating the program with a commercial inventory includes automatically loading said items into said listing based on a commercial expiration date and wherein said items are listed at a time after a commercial expiration date.

7. The system and method of claim 1 whereby said associating the program with a commercial inventory includes manually loading said items into said listing based on a commercial expiration date and wherein said items are listed at a time after a commercial expiration date.

8. The system and method of claim 1 wherein the system includes a list of customers that are notified when particular items are available in said system based on prior customer registration.

9. The system and method of claim 1 further comprising the step of alerting a commercial seller when said item is purchased from a customer.

10. The system and method of claim 1 further comprising the step of providing a seller an option to automatically reduce an item price in said system as an expiration time point approaches.

11. A system and method for selling commercial inventory comprising the steps of:
providing a program on a non-transitory computer readable medium;
providing at least one microprocessor based device selectively configured to run said program, whereby said device is constructed and arranged with input, output, and communications means;
associating said program with a commercial inventory;
providing a listing of items being goods, services, or combinations thereof available for sale from said commercial inventory;
providing access to said program to a customer;
listing items in said inventory for said customer based on selected parameters;
providing a means for said customer to selectively purchase items from said commercial inventory, whereby said commercial inventory is accessible and updated in real time.

12. A system and method for selling commercial inventory comprising the steps of:
providing a program on a non-transitory computer readable medium;
providing at least one microprocessor based device selectively configured to run said program, whereby said device is constructed and arranged with input, output, and communications means;
associating said program with a commercial inventory;
providing a listing of items being goods, services, or combinations thereof available for sale from said commercial inventory;
providing access to said program to a customer;
listing near-expiration items in said inventory for said customer based on selected parameters;
providing a means for said customer to selectively offer bids on items from said commercial inventory in real time.
